(19) United States
(12) Patent Application Publication
(10) Pub. No.: US 2016/0066156 A1
(43) Pub. Date: Mar. 3, 2016

(54) Selection of Location-Determination Information

(71) Applicant: Google Inc., Mountain View, CA (US)

(72) Inventors: Etienne Le Grand, Mountain View, CA (US); Brian John Julian, Mountain View, CA (US)

(21) Appl. No.: 14/621,991

(22) Filed: Feb. 13, 2015

Related U.S. Application Data
(60) Provisional application No. 62/043,702, filed on Aug. 29, 2014.

(51) Int. Cl. H04W 4/02; H04W 64/00

(52) U.S. Cl. CPC H04W 4/028; H04W 64/00

(57) ABSTRACT

An indication that a wireless computing device (WCD) is moving toward a physical setting may be received. The physical setting may include a particular topography. There may be at least (i) location-determination information of a first type and (ii) location-determination information of a second type. The location-determination information of the first type may facilitate low-resolution location determinations in the physical setting and the location-determination information of the second type may facilitate high-resolution location determinations in the physical setting. Based on the physical setting and the particular topography, location-determination information may be selected from at least (i) the location-determination information of the first type or (ii) the location-determination information of the second type. At least some of the selected location-determination information may be used to estimate a location of the WCD.

### CROSS-REFERENCE TO RELATED APPLICATION

This application claims priority to U.S. provisional patent application Ser. No. 62/043,702, filed Aug. 29, 2014, which is hereby incorporated by reference in its entirety.

### BACKGROUND

To determine the location of a device, such as a cell phone, tablet, laptop computer, or another type of wireless computing device, it may be desirable to obtain information that may be able to facilitate such determination. Global Positioning System (GPS) data may be used for this purpose, but might not be available in indoor settings, and may also use a relatively large degree of power. Other types of location-determination information can be used, but may be so voluminous that all location-determination information relevant to the device and its physical setting cannot be stored on the device at the same time.

### SUMMARY

Various types of location-determination information may exist. For instance, in addition to GPS data, cellular network wireless coverage area information, local-area wireless coverage area information (e.g., Wifi hotspot information), and magnetic field pattern information can be used to determine the location of a device. In some cases, a combination of two or more of these types of location-determination information may be used to achieve that goal. Certain types of location-determination information, such as local-area wireless coverage area information and magnetic field pattern information, may be extensive. Consequently, it may not be possible or practical to, for a given physical setting, simultaneously store all of these types of location-determination information on a device. In order to overcome this limitation, one or more particular types of location-determination information for the given physical setting may be selected as needed. The selection may be based on the device, one or more physical settings toward which the device is moving or is in, particular topographies included within these physical settings, and possibly other factors as well.

In a first example embodiment, an indication that a wireless computing device (WCD) is moving toward a physical setting may be received. The physical setting may include a particular topography. Possibly in response to receiving the indication that the WCD is moving toward the physical setting, it may be determined that there are at least (i) location-determination information of a first type and (ii) location-determination information of a second type. The location-determination information of the first type may facilitate low-resolution location determinations in the physical setting and the location-determination information of the second type may facilitate high-resolution location determinations in the physical setting. Based on the physical setting and the particular topography, location-determination information may be selected from at least (i) the location-determination information of the first type or (ii) the location-determination information of the second type. At least some of the selected location-determination information may be used to estimate a location of the WCD.

In a second example embodiment, an article of manufacture may include a non-transitory computer-readable medium, having stored thereon program instructions that, upon execution by a computing device, cause the computing device to perform operations in accordance with the first example embodiment.

In a third example embodiment, a computing device may include at least one processor, data storage, and program instructions. The program instructions may be stored in the data storage, and upon execution by the at least one processor may cause the computing device to perform operations in accordance with the first example embodiment.

In a fourth example embodiment, a system may include means for receiving an indication that a WCD is moving toward a physical setting. The physical setting may include a particular topography. The system may also include means for, possibly in response to receiving the indication that the WCD is moving toward the physical setting, determining that the system has access to at least (i) location-determination information of a first type and (ii) location-determination information of a second type. The location-determination information of the first type may facilitate low-resolution location determinations in the physical setting and the location-determination information of the second type may facilitate high-resolution location determinations in the physical setting. The system may further include means for, based on the physical setting and the particular topography, selecting location-determination information from at least (i) the location-determination information of the first type or (ii) the location-determination information of the second type. The system may additionally include means for using at least some of the selected location-determination information to estimate a location of the WCD while the WCD is in the physical setting.

These as well as other embodiments, aspects, advantages, and alternatives will become apparent to those of ordinary skill in the art by reading the following detailed description, with reference where appropriate to the accompanying drawings. Further, it should be understood that this summary and other descriptions and figures provided herein are intended to illustrate embodiments by way of example only and, as such, that numerous variations are possible. For instance, structural elements and process steps can be rearranged, combined, distributed, eliminated, or otherwise changed, while remaining within the scope of the embodiments as claimed.

### BRIEF DESCRIPTION OF THE DRAWINGS

FIG. 1 depicts a client/server networked environment, according to an example embodiment.

FIG. 2 illustrates a schematic drawing of a client device, according to an example embodiment.

FIG. 3 illustrates a schematic drawing of a server device, according to an example embodiment.

FIG. 4A illustrates a WCD in the range of several cellular base stations, according to an example embodiment.

FIG. 4B illustrates a WCD in the range of a Wifi access point, according to an example embodiment.

FIG. 4C illustrates a WCD in the range of several Wifi access points, according to an example embodiment.

FIG. 4D illustrates a WCD in the range of a larger number of Wifi access points, according to an example embodiment.

FIG. 4E illustrates a WCD in a room with a mapped magnetic field pattern, according to an example embodiment.

FIG. 5 is a flow chart, according to an example embodiment.

### DETAILED DESCRIPTION

Example methods, devices, and systems are described herein. Herein, the words “example” and “exemplary” are used herein to mean “serving as an example, instance, or illustration.” Any embodiment or feature described herein as being an “example” or “exemplary” is not necessarily to be construed as preferred or advantageous over other embodiments or features. Other embodiments can be utilized, and other changes can be made, without departing from the scope of the subject matter presented herein.

Thus, the described example embodiments are not intended to be limiting. Aspects of the present disclosure, as generally described herein and illustrated in the figures, can be arranged, substituted, combined, separated, and designed in a wide variety of different configurations, all of which are explicitly contemplated herein.

### 1. OVERVIEW

Various procedures may be carried out on a computing device to estimate a location of the computing device. For example, consider a scenario in which a computing device, such as a WCD, displays a map including the estimated location of the WCD. In particular, the map may display a dot representing this estimated location. In some instances, a GPS application may be running on the WCD to determine the estimated location. However, the GPS application might not display the dot on the map accurately, possibly due to a building or other structure preventing a clear GPS signal from reaching the WCD, among other possibilities. As such, the dot may “jump” around on the map, making it difficult to ascertain the actual location of the WCD. Further, GPS applications typically use a significant amount of power, possibly draining the battery of the WCD at an undesirable rate.

In such instances, one or more other types of location-determination information may be used to facilitate estimating the location of the WCD. These types may include cellular wireless coverage area information, local-area wireless coverage area information, magnetic field pattern information, and/or additional types of location-determination information. Particularly, when a WCD is indoors and more likely to suffer from poor GPS coverage, the WCD may be able to use one or more of these other types of location-determination information to provide an improved estimate of the WCD's location. Even when a WCD is outdoors and is able to receive GPS signals, it may be advantageous to use one or more of these other types of location-determination information in order to conserve battery life.

The type of location-determination information that is used may depend on the WCD's physical setting and the topography of the physical setting. A topography may be, for example, whether the WCD is indoors or outdoors, as well as the physical features in the WCD's vicinity that may impact the use of various types of location-determination mechanisms. For instance, the topography of an indoor setting may include the size of the room that the WCD is in, and/or the composition of the walls of the room. The topography of the outdoor setting may include the shape and features of the of the Earth's surface (e.g., plains, hills, mountains, trees, etc.). Other topography characteristics may include whether the magnetic field is known to be constant in a building (this happens in some wooden buildings), whether the building possesses many Wifi and/or Bluetooth (including Bluetooth Low Energy) wireless emitters, and/or whether the building possesses mostly corridors and narrow spaces, or big open spaces where people can roam freely. Each of these characteristics provides information that can influence the selected location-determination information.

The embodiments herein provide example procedures, WCDs, computing devices, and systems for selection of location-determination information based on a physical setting toward which a WCD is moving or is in, as well as the particular topography of this physical setting. The next section describes illustrative examples of such WCDs, computing devices, server devices, and systems.

### 2. EXAMPLE WCDS, COMPUTING DEVICES, AND SYSTEMS

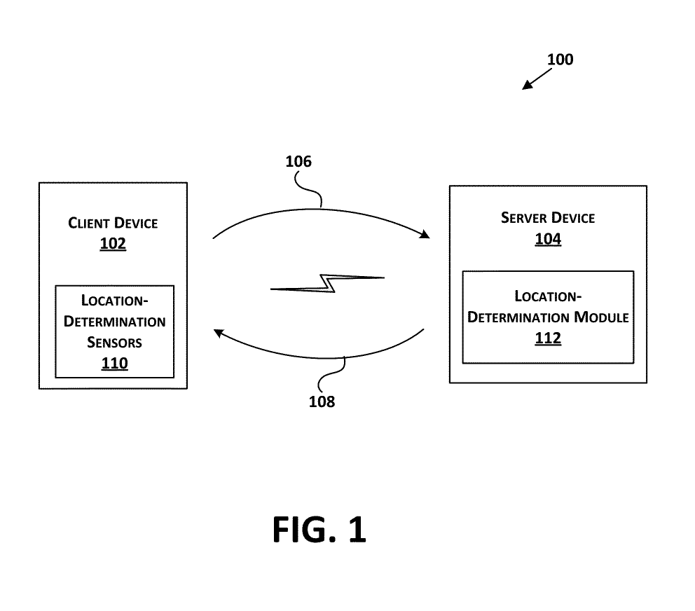

FIG. 1 illustrates an example communication system 100 for carrying out one or more of the embodiments described herein. In some instances, communication system 100 may include computing devices for carrying out one or more of the operations or procedures described herein. Herein, a “computing device” may refer to either a client device (e.g., a WCD), a server device (e.g., a networked cluster of server equipment), or some other type of computational platform.

Client device 102 may be any type of device including a laptop computer, a wearable computing device, a WCD, a head-mountable computing device, a mobile telephone, or tablet computing device, etc., that is configured to transmit data 106 to and/or receive data 108 from a server device 104 in accordance with the embodiments described herein. For example, in FIG. 1, client device 102 may communicate with server device 104 via one or more wireless interfaces. Client device 102 and server device 104 may communicate with one another via a local-area network. Alternatively, client device 102 and server device 104 may each reside within a different network, and may communicate via a wide-area network, such as the Internet.

Client device 102 may include a user interface, a communication interface, a processor, and data storage (e.g., memory). The data storage may contain instructions executable by the processor for carrying out one or more operations relating to the data sent to, or received from, server device 104. The user interface of client device 102 may include buttons, a touchscreen, a microphone, and/or any other elements for receiving inputs, as well as a speaker, one or more displays, and/or any other elements for communicating outputs. Client device 102 may include location-determination sensors 110 (e.g., a GPS transceiver, a Wifi interface, and/or a compass) that can be used to assist in estimating the location of client device 102.

Server device 104 may be any entity or computing device arranged to carry out the operations described herein. Further, server device 104 may be configured to send data 108 to and/or receive data 106 from the client device 102. Server device 104 may include a location-determination module 112 which may be configured to process data 106 received from the client device 102 to determine one or more estimated locations (present and/or historical) associated with client device 102. In some cases, location-determination module 112 may include a database of location information, and may be incorporated into server device 104 (as shown in FIG. 1) or may exist separately from server device 104.

Data 106 may take various forms. For example, client device 102 may provide information indicative of an approximate location of client device 102, movement of client device 102, and/or inputs from a user of client device 102. Server device 104 may then process data 106 to identify location-determination information and/or location history information that matches or is related to the received data 106.

Data 108 may also take various forms. For example, server device 104 may send client device 102 an indication of one or more estimated locations of client device 102, updated location history information, or information based on the approximate location of client device 102. Further, server device 104 may send client device 102 information regarding the physical setting(s) surrounding the estimated location of client device 102. In some embodiments, data 108 may include location-determining information (e.g., cellular wireless coverage area information, local-area wireless coverage area information, and/or magnetic field pattern information) that client device 102 can use to develop a more accurate estimate of its location.

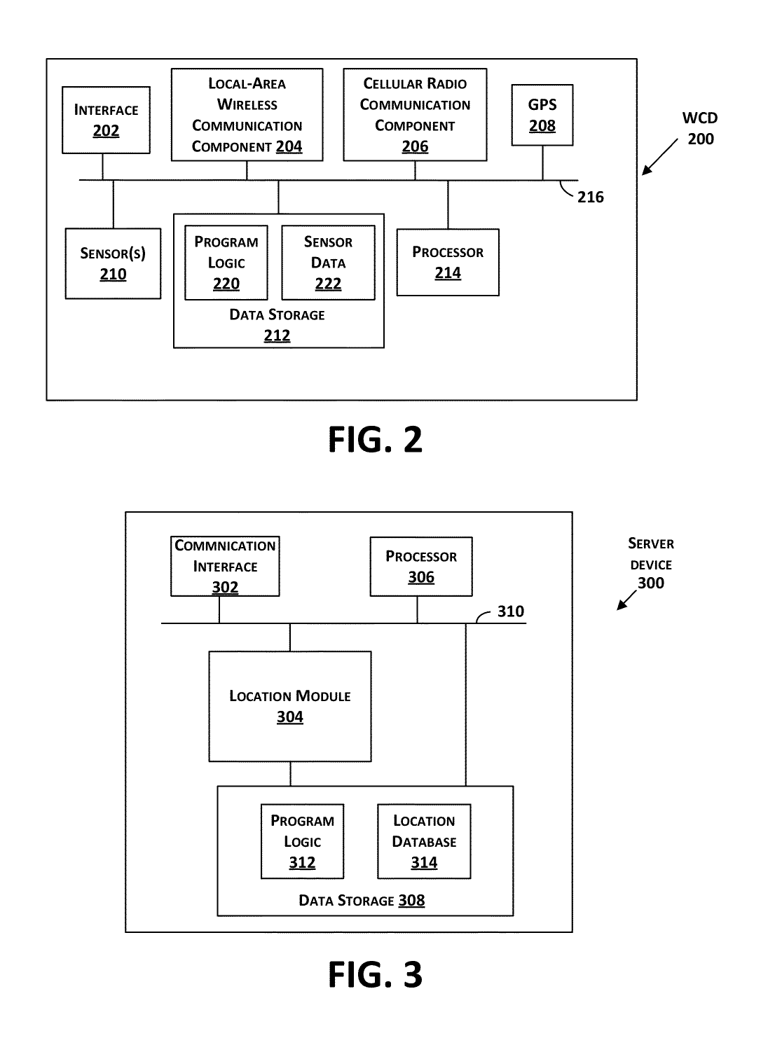

FIG. 2 illustrates a schematic drawing of an example WCD 200, where WCD 200 is an example embodiment of client device 102. Thus, WCD 200 may, for example, take the form of any client device described above in relation to FIG. 1. In some examples, components illustrated in FIG. 2 may be distributed across multiple client devices. Nonetheless, for illustrative purposes, components are shown and described in FIG. 2 as part of an example WCD 200.

In some implementations, WCD 200 may include a device platform or operating system (not shown). The device platform may include different applications and an application framework, as well as various kernels, schedulers, memory managers, libraries, and runtime entities. In other examples, other formats or systems may operate on WCD 200 as well.

WCD 200 may include an interface 202, a local area wireless communication component 204, a cellular radio communication component 206, a GPS component 208, sensor(s) 210, data storage 212, and a processor 214. Components illustrated in FIG. 2 may be linked together by a communication bus 216. WCD 200 may also include additional hardware to enable further functionality and/or operations.

Interface 202 may be configured to allow a user to interact with WCD 200. Thus, interface 202 may include user-interface components, such as a keyboard, microphone, touchscreen, touchpad, display, speaker, etc.

Local-area wireless communication component 204 may be a communication interface that is configured to facilitate wireless data communication according to one or more wireless communication standards or non-standard protocols. For example, local-area wireless communication component 204 may include a Wifi communication component that is configured to facilitate wireless data communication according to one or more IEEE 802.11 protocols. As another example, local-area wireless communication component 204 may include a Bluetooth communication component that is configured to facilitate wireless data communication according to one or more Bluetooth protocols. Other examples are also possible.

Cellular radio communication component 206 may be a communication interface that is configured to facilitate wireless data and/or voice communication according to one or more wide-area wireless communication standards or non-standard protocols. For example, cellular radio communication component 206 may be configured to facilitate wireless data communication according to Code Division Multiple Access (CDMA), Worldwide Interoperability for Microwave Access (WIMAX), Universal Mobile Telecommunications System (UMTS), Long Term Evolution (LTE), or other protocols now known or later developed.

GPS component 208 may be a GPS transceiver configured to receive GPS signals from one or more satellites, and to estimate a location of WCD 200. Sensor(s) 210 may include one or more of an accelerometer, gyroscope, magnetometer, inertial measurement unit (IMU), compass, pedometer, light sensor, microphone, camera, and/or other location and/or context-aware sensors.

Data storage 212 may store program logic 220 that can be accessed and executed by processor 214. Program logic 220 may include machine-readable instructions that, when executed by processor 214, cause WCD 200 to carry out various operations and procedures. Data storage 212 may also store collected sensor data 222 that may include data collected by any of local-area wireless communication component 204, cellular radio communication component 206, GPS 208, and/or any of sensors 210. Data storage 212 may store additional data as well. Data storage 212 may be a non-transitory computer-readable data medium, such as a hardware memory module.

Processor 214 may be any type of one or more microprocessors or general-purpose processors. However, processor 214 may be integrated with or include various types of co-processors, network processors, graphics processors, and/or digital logic.

Communication bus 216 is illustrated as a wired connection; however, wireless connections may also be used. For example, communication bus 216 may be a wired serial bus such as a universal serial bus or a parallel bus, or a wireless connection using, e.g., short-range wireless radio technology, communication protocols described in IEEE 802.11 (including any IEEE 802.11 revisions), or cellular technology, among other possibilities.

FIG. 3 illustrates a schematic drawing of another example computing device, server device 300. In examples, some components illustrated in FIG. 3 may be distributed across multiple servers. However, for the sake of illustration and simplicity, the components are shown and described as part of one example server device 300. Server device 300 may be a computing device, cloud-based server, or similar entity that may be configured to perform the functions described herein.

Server device 300 may include a communication interface 302, a location module 304, a processor 306, and data storage 308. All of the components illustrated in FIG. 3 may be linked together by a communication bus 310 (e.g., a wired or wireless link).

Communication interface 302 may allow server device 300 to communicate with another device (not shown), such as a WCD described above in relation to FIG. 2. Thus, communication interface 302 may be configured to receive input data from one or more computing devices, and may also be configured to send output data to the one or more computing devices (e.g., WCDs or other types of client devices).

Location module 304 may be configured to receive data from a client device (e.g., a WCD or another type of client device) and determine a geographic location of the computing device. The determination may be based on data received from the client device, the data being further based on outputs of an accelerometer, gyroscope, magnetometer, and/or other sensors of the client device. Location module 304 may further be configured to determine and store a history of sensor measurements of the client device for later reprocessing based on updated data pertaining to networks or information used to the determine the locations. Location module 304 may include program logic or digital logic that interacts with location information stored in location database 314.

Data storage 308 may store program logic 312 that can be accessed and executed by processor 306. Data storage 308 may also include location database 314 that can be accessed by processor 306 as well, for example, to retrieve location-determination information. Like data storage 212, data storage 308 may be a non-transitory computer-readable data medium, such as a hardware memory module. Also, like processor 214, processor 306 may be any type of one or more microprocessors or general-purpose processors, and may be integrated with or include various types of co-processors, network processors, graphics processors, and/or digital logic.

Location database 314 may include or have access to one or more databases of location-determination information. This information may include, but is not limited to, digital representations of maps, locations of cellular base stations and/or wireless coverage areas defined by these base stations, locations of Wifi access points, Bluetooth (including Bluetooth Low Energy) beacons, and/or wireless coverage areas defined by these access points. The information may further include magnetic field pattern information for specific structures, rooms within these structures, and/or any other type of information useful for determining a location of a client device. Some additional types of information may include wireless emitter (e.g., base station and/or access point) signal strength fingerprint maps, wireless emitter round-trip latency fingerprint maps, walking paths, elevators, stairs, ramps, and so on. In some embodiments, location database 314 is stored separately from server device 300, for instance in a distinct physical location and/or on a distinct physical device.

For sake of simplicity, the terms “base station” and “access point” will be used herein to include any type of wireless emitter, including but not limited those operating in accordance with cellular protocols, Wifi protocols, Bluetooth protocols, or any other protocol now known or developed in the future.

### 3. EXAMPLE LOCATION-DETERMINATION INFORMATION

A device with a GPS receiver may estimate its position from signals transmitted by GPS satellites. Based on the times that each signal was transmitted and the transmitting satellite's position at these times, the GPS receiver may compute its distance to each satellite (e.g., by using the speed of light).

Typically, the GPS receiver uses signals from four or more satellites to obtain an accurate estimate of its location. This location might include both a position on the surface of the earth (e.g., longitude and latitude), as well as an altitude. Some GPS receivers take multiple location measurements to infer their velocity and direction of movement.

GPS signals typically use microwave transmission, which is often not suitable for indoor reception. For instance, microwaves can be attenuated and scattered by the roofs and walls of various types of structures. As an example, when a user of a WCD is outside of a structure, such as in the parking lot of an airport, the WCD might receive strong GPS signals. However, when the user moves into the airport, the WCD might be unable to accurately resolve its location using just GPS. Thus, other types of location-determination information might be used for this purpose.

An overview of several additional types of location-determination information is provided below.

A. Cellular Wireless Coverage Area Information

Many locations worldwide, especially heavily-populated locations, are served by one or more cellular networks. Each of these cellular networks may provide telephony and/or data services to subscribed WCDs within their respective coverage areas. To do so, these cellular networks include multiple base stations, each radiating on one or more carrier frequencies to define one or more wireless coverage areas.

In operation, a WCD may receive pilot signals and/or other signaling or bearer traffic from one or more wireless coverage areas. In this way, the WCD can measure the strengths at which it receives these signals, in order to determine, for instance, when to request a handover from one wireless coverage area to another.

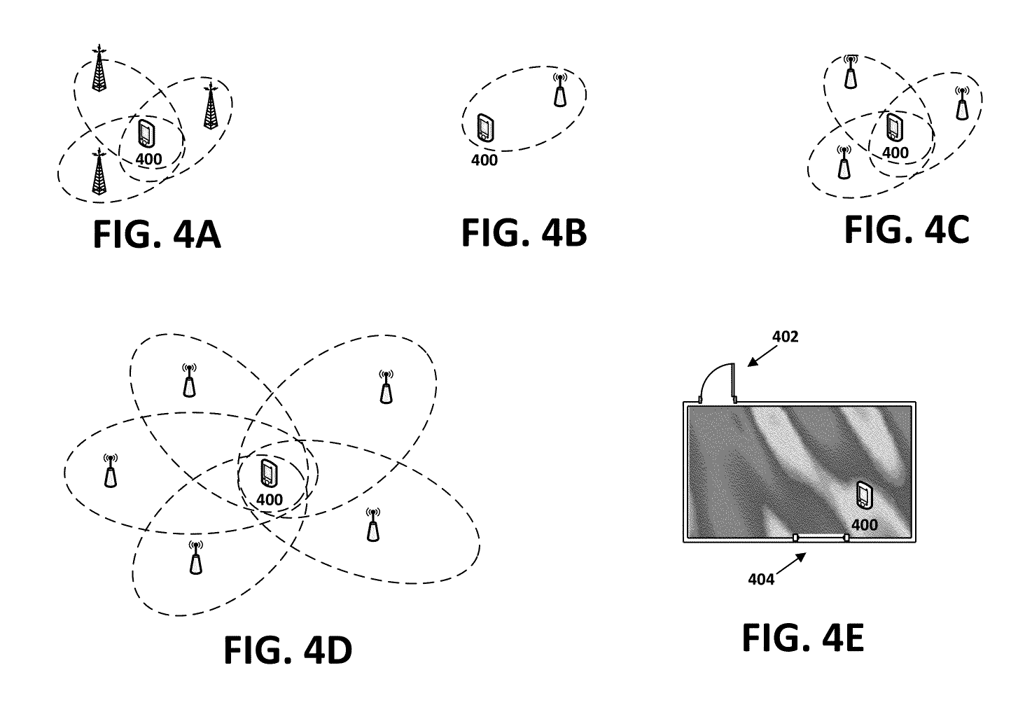

When a WCD receives signals from three or more wireless coverage areas, the WCD may be able to estimate its location through triangulation of these signals. An example of being able to provide a reasonable estimate of a WCD's location is shown in FIG. 4A. WCD 400 is within range of three wireless coverage areas, each wireless coverage area defined by a different cellular base station.

Triangulation may involve the WCD estimating the distance between itself and each of the three or more base stations. Such an estimate may be based on received signal strengths from these base stations and/or the round-trip time of the received signals. In order to perform the estimate, the location-determining information may contain associations of base stations (e.g., base station identifiers) and/or wireless coverage areas (e.g., sector identifiers) with physical locations (e.g., latitude, longitude, and/or altitude). In some embodiments, more than one wireless coverage area per base station may be used.

Depending on the density of base stations surrounding the WCD, estimates of the WCD's location may have an accuracy within a few hundred feet to a mile of the WCD's actual location. In urban environments, base station deployments may be very dense, but reflections and interference from “urban canyon” environments may further reduce the accuracy of this technique.

In some cases it may be possible for a WCD to download and store cellular network wireless coverage area information for an entire country or a region of a country. Yet, as described above, the accuracy of the WCD's location estimation using this information is limited.

B. Sparse Local-Area Wireless Coverage Area Information

Given the widespread deployment of local area wireless networking equipment (e.g. Wifi access points), it may be possible to use this equipment to estimate the location of a WCD. For instance, a database of access point coverage may be developed. This database may include indications of each access point's service set identification (SSID) and/or its medium access control (MAC) address. IP addresses assigned to access points may also be included. These parameters may be associated with the physical location (e.g., latitude, longitude, and/or altitude) of each respective access point. Additionally, aside from using Wifi access point information for location-determination purposes, other types of wireless network technology may be used, such as Bluetooth and/or near-field communication (NFC).

In some settings, access point deployment may be sparse; for instance, a WCD may be within range of only one or two access points. Based on information in the database, the WCD's general location may be able to be determined. For example, using sparse local-area wireless coverage area information, the WCD's location may be determined to be in or near a particular building, with within or near some subset of locations within the building. For instance, the WCD's location may be estimated within a few tens or hundreds of feet.

An example of using this type of location-determination information is shown in FIG. 4B. WCD 400 is within range of just one access point. Thus, the location of WCD 400 may be estimated based on the location of the access point as stored in a location-determination database.

Sparse local-area wireless coverage area information may be downloaded, from a server to a WCD, on demand or as needed. For instance, as the WCD nears a particular physical setting, the WCD may receive sparse local-area wireless coverage area information regarding nearby access points. Since the volume of sparse local-area wireless coverage area information is typically not large, this information may be downloaded and stored for an entire geographical region (e.g., a city or a county) at a time.

C. Local-Area Wireless Coverage Area Triangulation Information

In some environments, such as airports, office buildings, or commercial buildings, multiple Wifi access points may be deployed such that their respective wireless coverage areas overlap to some extent. In these less sparse deployments, triangulation may be used with these access points to more accurately estimate the location of the WCD. As was the case for sparse local-area wireless coverage area information, other types of wireless network technology may be used, such as Bluetooth and/or NFC.

For example, as shown in FIG. 4C, a WCD 400 may use three (or more) nearby access points to determine its location. As described above for cellular triangulation, the WCD may estimate the distance between itself and the access points based on received signal strengths from these access points and/or estimates of the round-trip delays between the WCD and the access points. Thus, the WCD may measure the strength at which it receives signals from the access points, and/or may use a “ping”-like utility to measure the round-trip delays between itself and the access point.

Using local-area wireless coverage area triangulation information, the WCD's location may be determined to be in or near a particular part of a building, or within or near one or more rooms of the building. For instance, the WCD's location may be estimated within a few dozen feet.

Local-area wireless coverage area triangulation information may be downloaded, from a server to a WCD, on demand or as needed. For instance, as the WCD nears a particular physical setting, the WCD may receive local-area wireless coverage area triangulation information regarding nearby access points. Since the volume of local-area wireless coverage area triangulation information may be large, this information may be downloaded and stored for a limited geographical region (e.g., a few buildings or a radius of a mile around the WCD) at a time.

D. Dense Local-Area Wireless Coverage Area Information

In some physical settings, such as heavily used office buildings, apartment complexes, and so on, a large number of Wifi access points may be present. In these environments, a three-dimensional (3D) map of the locations of the access points may be developed. For instance, a “fingerprint” of a particular access point may be determined based on the strength at which signals from the access point can be received at various locations in 3D space. In some cases, it is not required to know or estimate the access point's position. Instead, the map may include the received signal strengths (or expected round-trip latencies) expected at various positions in the 3D space.

For example, as shown in FIG. 4D, a WCD 400 may use several nearby access points to determine its location. WCD 400 may have access to a signal strength map of at least one of the respective wireless coverage areas. For this wireless coverage area, the map may indicate that received signal strength is typically between values S1 and S2 (where S1>S2) when a WCD is up to 10 feet from the access point, between values S2 and S3 (where S2>S3) when the WCD is between 10 and 20 feet from the access point, and so on. In combination with similar information regarding other access points, and possibly triangulation as well, a WCD may be able to be located in 3D space to an accuracy within 10 feet.

Dense local-area wireless coverage area information may be downloaded, from a server to a WCD, on demand or as needed. For instance, as the WCD nears a particular physical setting, the WCD may receive dense local-area wireless coverage area information regarding nearby access points. Since the volume of dense local-area wireless coverage area information may be significant, this information may be downloaded and stored for one or more floors of a single building, or a small number of buildings, at a time.

E. Magnetic Field Pattern Information

The Earth's magnetic field can be used for both orientation and navigation. Anomalies in the magnetic field may be used to derive positional information of a WCD. For instance, buildings with concrete and/or steel infrastructure may have unique, spatially-varying magnetic fields that can be used to identify the position of an object in these buildings. These non-uniform magnetic fields may produce different magnetic observations, depending on the path through which they are navigated.

As an example, an application operating on a WCD may use the WCD's compass to observe and record the magnetic field patterns in a particular room of a particular building. This information is then tagged with geographic coordinates (e.g., a GPS location and/or longitude, latitude, and height), and then uploaded to database of such observations. When the database is sufficiently populated, this information can be made available to WCDs for location-determination purposes.

As an example, FIG. 4E illustrates a magnetic field pattern for a room in which WCD 400 is located. Anomalies in the magnetic field may be due to the presence of door 402 and window 404. FIG. 4E also demonstrates the level of detail available in a magnetic field pattern. Fluctuations in the magnetic field can be measured down to the granularity of a few inches.

One advantage that magnetic field pattern information may have over other types of location-determination information is that it does not rely on the presence of network equipment (e.g., GPS satellites, cellular base stations, or Wifi access points) to estimate a WCD's location. Instead, the WCD may estimate its location based on a comparison of the magnetic field pattern it is currently detecting and previously-stored magnetic field pattern information for the same general location. Thus, using magnetic field pattern information may be able to allow location estimates to take place where wireless signals are unlikely to penetrate, such as shielded rooms and underground locations. Another advantage to magnetic field pattern information is that the magnetic field has three components everywhere in space (e.g., orthogonal strength components in the x, y, and z directions), and the values measured by the WCD depends on both the WCD position and the WCD orientation. This means that with magnetic field pattern information, the location information may include the position of the WCD and the orientation of the WCD.

Magnetic field pattern information may be downloaded, from a server to a WCD, on demand or as needed. For instance, as the WCD nears a particular physical setting, the WCD may receive magnetic field pattern information regarding nearby rooms, hallways or structures. Since the volume of magnetic field pattern information may be quite large, this information may be downloaded and stored for small geographic areas (e.g., one or more rooms or areas within a building at a time).

### 4. EXAMPLE OPERATIONS

With respect to the various types of location-determination information described above, there may be a trade-off between location-determination accuracy and the extent of location-determination information used to obtain estimates with that accuracy. Low-accuracy location estimates can be made using cellular wireless coverage area information, and this information may require relatively little storage. At the other extreme, high-accuracy estimates can be made using magnetic field pattern information, and this information may require a significant amount of storage. In some embodiments, the amount of storage required for some types of location-determination information may be such that a WCD dynamically downloads and stores only portions of the location-determination information at a time.

Determining what portions of this location-determination information is to be downloaded may be based on a number of factors, including the WCD's most recently determined location, the direction and speed of the WCD's movement, the amount of storage available on the WCD, the data rate of the network(s) that the WCD can use to download this information, as well as information from applications on the WCD.

For instance, if the WCD uses a mapping application, the user of the WCD may have requested a route from the WCD's current location to a destination. The WCD may then proactively download location-determination information related to this route. For instance, the WCD might download lower-accuracy location-determination information for where the route includes highways or high-speed roads, and higher-accuracy location-determination information in the area of the destination.

If the WCD uses a calendar application, this application may include indications of when and where the user of the WCD is expected to be in the future. For example, if a calendar entry indicates that the user has a meeting in a particular room of a building at a particular time, the WCD may proactively download high-accuracy location-determination information for this room (and possibly one or more routes to this room) prior to the time of the meeting.

Similar decisions may be made based on information in the WCD's email applications, search applications (e.g., search history), location history (e.g., where the WCD typically goes at various times of day), and so on. For instance, in some embodiments, higher-accuracy location-determination information may be downloaded to the WCD for the places where the WCD requested higher-accuracy location-determination information in the past, and/or places in which other WCDs requested higher-accuracy location-determination information in the past.

As a possible example, suppose that the user of a WCD requests a route, in the WCD's mapping application, to an airport. If the route involves highways, the WCD may download and/or use stored cellular wireless coverage area information to provide location services to the WCD while in transit to the airport.

Before or upon arriving at the airport, the WCD may determine that the WCD's ultimate destination is a particular terminal. This may be determined, for instance, from an airline confirmation email in the WCD's email application. The WCD may request and receive more accurate location-determination information, such as sparse local-area wireless coverage area information and/or local-area wireless coverage area triangulation information for the entire airport. The WCD may use this information to provide location services to the WCD while the WCD is in most parts of the airport.

At some point, the WCD may determine that the WCD is likely to pass through a tunnel in order to get to the particular terminal. Thus, the WCD may request and receive even more accurate location-determination information for the tunnel, such as dense local-area wireless coverage area information and/or magnetic field pattern information. The WCD may use this information to provide location services to the WCD while the WCD is in the tunnel.

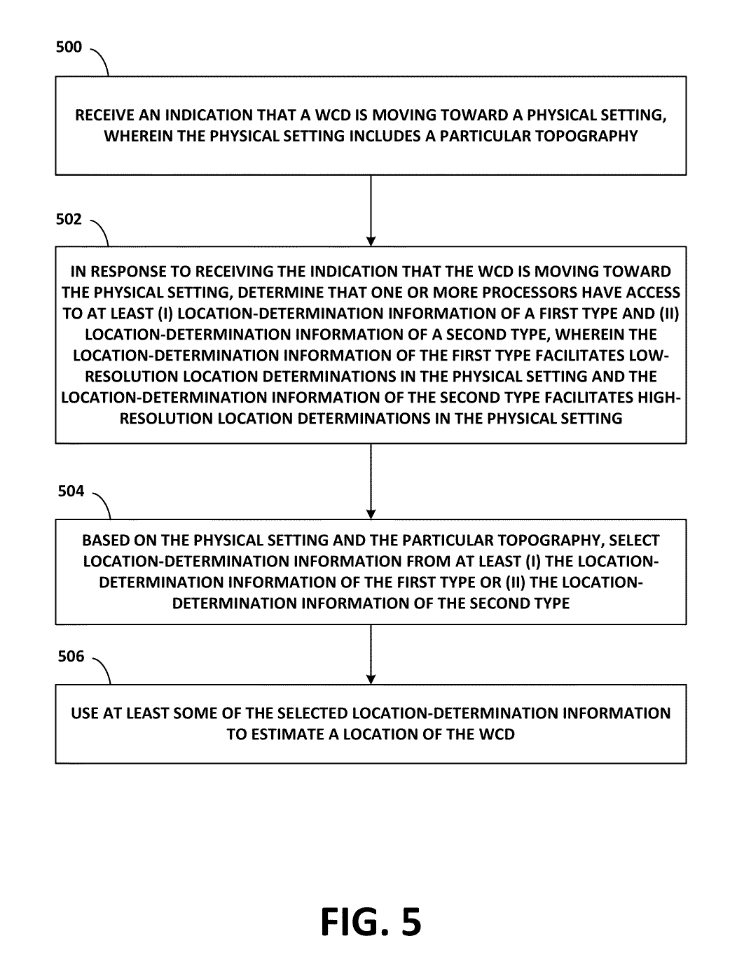

FIG. 5 is a flow chart illustrating an example embodiment. The procedure illustrated by FIG. 5 may be carried out by a computing device, such as WCD 200, server device 300, or by some combination of these devices. However, the procedure can be carried out by other types of devices or device subsystems. Further, the procedure may incorporate any aspect or feature disclosed herein.

At block 500, a computing device (e.g., a WCD or server device), or one or more processors (e.g., of the WCD or server device), may receive an indication that the WCD is moving toward a physical setting. The physical setting may include a particular topography.

At block 502, possibly in response to receiving the indication that the WCD is moving toward the physical setting, the computing device (or the one or more processors) may determine that it has access to at least (i) location-determination information of a first type and (ii) location-determination information of a second type. The location-determination information of the first type may facilitate low-resolution location determinations in the physical setting and the location-determination information of the second type may facilitate high-resolution location determinations in the physical setting.

At block 504, possibly based on the physical setting and the particular topography, the computing device (or the one or more processors) may select location-determination information from at least (i) the location-determination information of the first type or (ii) the location-determination information of the second type. At block 506, at least some of the selected location-determination information may be used to estimate a location of the WCD. The location may be estimated while the WCD is in the physical setting.

Determining that the computing device (or the one or more processors) has access to at least (i) location-determination information of the first type and (ii) location-determination information of the second type may involve determining that the computing device (or the one or more processors) also has access to location-determination information of a third type. The location-determination information of the third type may facilitate medium-resolution location determinations in the physical setting. Selecting the location-determination information may involve selecting the location-determination information of the third type.

In some situations, the location-determination information of the first type includes cellular wireless coverage areas within or proximate to the physical setting, and the location-determination information of the second type includes local-area wireless coverage areas within or proximate to the physical setting. In other situations, wherein the location-determination information of the first type includes local-area wireless coverage areas within or proximate to the physical setting, and the location-determination information of the second type includes magnetic field patterns within or proximate to the physical setting. These wireless coverage areas may provide wireless coverage to some or all of the physical setting.

Certain embodiments may involve determining that the particular topography includes a building. In these embodiments, the location-determination information of the second type may be selected in response to the particular topography including the building (e.g., size of one or more rooms, number of floors in the building, density of the buildings walls, etc.).

Other embodiments may involve determining that the particular topography includes a road. In these other embodiments, the location-determination information of the first type may be selected in response to the particular topography including the road. For instance, a high-speed road, such as a highway, may result in low-resolution location-determination information being selected. In general, the resolution of the selected location-determination information may be inversely proportion to the speed at which the WCD is expected to travel.

Using at least some of the selected location-determination information to estimate the location of the WCD while the WCD is in the physical setting may involve determining, by the computing device (or the one or more processors), an estimate of the location of the WCD from the selected location-determination information, and transmitting, to the WCD, the estimate of the location of the WCD. Alternatively or additionally, using at least some of the selected location-determination information to estimate the location of the WCD while the WCD is in the physical setting may involve transmitting, to the WCD, at least some of the selected location-determination information.

The indication that the WCD is moving toward the physical setting may be based on a direction of movement and a velocity of the WCD. Alternatively or additionally, the indication that the WCD is moving toward the physical setting is based on email, calendar, search, or map application information from the WCD. As a further aspect, the indication that the WCD is moving toward the physical setting may be based on historical movement information of the WCD.

In additional embodiments, the computing device (or the one or more processors) may receive an indication that the WCD is moving from the physical setting to a second physical setting. The second physical setting may include a second particular topography. In some case, the second particular topography may be different from the first particular topography.

Possibly in response to receiving the indication that the WCD is moving from the physical setting to the second physical setting, the computing device (or the one or more processors) may determine that it has access to (i) additional location-determination information of the first type and (ii) location-determination information of a third type. The additional location-determination information of the first type may facilitate low-resolution location determinations in the second physical setting and the location-determination information of the third type may facilitate medium-resolution location determinations in the second physical setting.

Possibly based on the second physical setting and the second particular topography, the computing device (or the one or more processors) may select second location-determination information from at least (i) the additional location-determination information of the first type or (ii) the location-determination information of the third type. At least some of the selected second location-determination information may be used to estimate a second location of the WCD while the WCD is in the second physical setting.

### 5. CONCLUSION

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims.

The above detailed description describes various features and functions of the disclosed systems, devices, and methods with reference to the accompanying figures. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

With respect to any or all of the message flow diagrams, scenarios, and flow charts in the figures and as discussed herein, each step, block, and/or communication can represent a processing of information and/or a transmission of information in accordance with example embodiments. Alternative embodiments are included within the scope of these example embodiments. In these alternative embodiments, for example, functions described as steps, blocks, transmissions, communications, requests, responses, and/or messages can be executed out of order from that shown or discussed, including substantially concurrent or in reverse order, depending on the functionality involved. Further, more or fewer blocks and/or functions can be used with any of the ladder diagrams, scenarios, and flow charts discussed herein, and these ladder diagrams, scenarios, and flow charts can be combined with one another, in part or in whole.

A step or block that represents a processing of information can correspond to circuitry that can be configured to perform the specific logical functions of a herein-described method or technique. Alternatively or additionally, a step or block that represents a processing of information can correspond to a module, a segment, or a portion of program code (including related data). The program code can include one or more instructions executable by a processor for implementing specific logical functions or actions in the method or technique. The program code and/or related data can be stored on any type of computer readable medium such as a storage device including a disk, hard drive, memory, or other storage medium.

The computer readable medium can also include non-transitory computer readable media such as computer-readable media that store data for short periods of time like register memory, processor cache, and random access memory (RAM). The computer readable media can also include non-transitory computer readable media that store program code and/or data for longer periods of time. Thus, the computer readable media may include secondary or persistent long term storage, like read only memory (ROM), optical or magnetic disks, compact-disc read only memory (CD-ROM), for example. The computer readable media can also be any other volatile or non-volatile storage systems. A computer readable medium can be considered a computer readable storage medium, for example, or a tangible storage device.

Moreover, a step or block that represents one or more information transmissions can correspond to information transmissions between software and/or hardware modules in the same physical device. However, other information transmissions can be between software modules and/or hardware modules in different physical devices.

The particular arrangements shown in the figures should not be viewed as limiting. It should be understood that other embodiments can include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims.

What is claimed is:

1. A method comprising:
receiving an indication that a wireless computing device is moving toward a physical setting, wherein the physical setting includes a particular topography;
in response to receiving the indication that the wireless computing device is moving toward the physical setting, determining, by one or more processors, that the one or more processors have access to at least (i) location-determination information of a first type and (ii) location-determination information of a second type, wherein the location-determination information of the first type facilitates low-resolution location determinations in the physical setting and the location-determination information of the second type facilitates high-resolution location determinations in the physical setting;
based on the physical setting and the particular topography, selecting location-determination information from at least (i) the location-determination information of the first type or (ii) the location-determination information of the second type; and
using at least some of the selected location-determination information to estimate a location of the wireless computing device.

2. The method of claim 1, further comprising:
receiving an indication that the wireless computing device is moving from the physical setting to a second physical setting, wherein the second physical setting includes a second particular topography;
in response to receiving the indication that the wireless computing device is moving from the physical setting to the second physical setting, determining that the one or more processors have access to (i) additional location-determination information of the first type and (ii) location-determination information of a third type, wherein the additional location-determination information of the first type facilitates low-resolution location determinations in the second physical setting and the location-determination information of the third type facilitates medium-resolution location determinations in the second physical setting;
based on the second physical setting and the second particular topography, selecting second location-determination information from at least (i) the additional location-determination information of the first type or (ii) the location-determination information of the third type; and
using at least some of the selected second location-determination information to estimate a second location of the wireless computing device while the wireless computing device is in the second physical setting.

3. The method of claim 1, wherein determining that the computing device has access to at least (i) location-determination information of the first type and (ii) location-determination information of the second type comprises determining that the one or more processors also have access to location-determination information of a third type, wherein the location-determination information of the third type facilitates medium-resolution location determinations in the physical setting, and wherein selecting the location-determination information comprises selecting the location-determination information of the third type.

4. The method of claim 1, wherein the location-determination information of the first type includes cellular wireless coverage areas within or proximate to the physical setting, and wherein the location-determination information of the second type includes local-area wireless coverage areas within or proximate to the physical setting.

5. The method of claim 1, wherein the location-determination information of the first type includes local-area wireless coverage areas within or proximate to the physical setting, and wherein the location-determination information of the second type includes magnetic field patterns within or proximate to the physical setting.

6. The method of claim 1, further comprising:
determining that the particular topography includes a building, wherein the location-determination information of the second type is selected in response to the particular topography including the building.

7. The method of claim 1, further comprising:
determining that the particular topography includes a road, wherein the location-determination information of the first type is selected in response to the particular topography including the road.

8. The method of claim 1, wherein using at least some of the selected location-determination information to estimate the location of the wireless computing device comprises:
determining an estimate of the location of the wireless computing device from the selected location-determination information; and
transmitting, to the wireless computing device, the estimate of the location of the wireless computing device.

9. The method of claim 1, wherein using at least some of the selected location-determination information to estimate the location of the WCD comprises:
transmitting, to the wireless computing device, at least some of the selected location-determination information.

10. The method of claim 1, wherein the indication that the wireless computing device is moving toward the physical setting is based on a direction of movement and a velocity of the wireless computing device.

11. The method of claim 1, wherein the indication that the wireless computing device is moving toward the physical setting is based on email, calendar, search, or map application information from the wireless computing device.

12. The method of claim 1, wherein the indication that the wireless computing device is moving toward the physical setting is based on historical movement information of the wireless computing device.

13. An article of manufacture including a non-transitory computer-readable medium, having stored thereon program instructions that, upon execution by a computing device, cause the computing device to perform operations comprising:
receiving an indication that a wireless computing device is moving toward a physical setting, wherein the physical setting includes a particular topography;
in response to receiving the indication that the wireless computing device is moving toward the physical setting, determining that the computing device has access to at least (i) location-determination information of a first type and (ii) location-determination information of a second type, wherein the location-determination information of the first type facilitates low-resolution location determinations in the physical setting and the location-determination information of the second type facilitates high-resolution location determinations in the physical setting;
based on the physical setting and the particular topography, selecting location-determination information from at least (i) the location-determination information of the first type or (ii) the location-determination information of the second type; and
using at least some of the selected location-determination information to estimate a location of the wireless computing device while the wireless computing device is in the physical setting.

14. The article of manufacture of claim 13, wherein determining that the computing device has access to at least (i) location-determination information of the first type and (ii) location-determination information of the second type comprises determining that the computing device also has access to location-determination information of a third type, wherein the location-determination information of the third type facilitates medium-resolution location determinations in the physical setting, and wherein selecting the location-determination information comprises selecting the location-determination information of the third type.

15. The article of manufacture of claim 13, wherein the operations further comprise:
determining that the particular topography includes a building, wherein the location-determination information of the second type is selected in response to the particular topography including the building.

16. The article of manufacture of claim 13, wherein the operations further comprise:
determining that the particular topography includes a road, wherein the location-determination information of the first type is selected in response to the particular topography including the road.

17. A computing device comprising:
at least one processor;
memory; and
program instructions, stored in the memory, that upon execution by the at least one processor cause the computing device to perform operations comprising:
receiving an indication that a wireless computing device is moving toward a physical setting, wherein the physical setting includes a particular topography;
in response to receiving the indication that the wireless computing device is moving toward the physical setting, determining that the computing device has access to at least (i) location-determination information of a first type and (ii) location-determination information of a second type, wherein the location-determination information of the first type facilitates low-resolution location determinations in the physical setting and the location-determination information of the second type facilitates high-resolution location determinations in the physical setting;
based on the physical setting and the particular topography, selecting location-determination information from at least (i) the location-determination information of the first type or (ii) the location-determination information of the second type; and
using at least some of the selected location-determination information to estimate a location of the wireless computing device while the wireless computing device is in the physical setting.

18. The computing device of claim 17, wherein determining that the computing device has access to at least (i) location-determination information of the first type and (ii) location-determination information of the second type comprises determining that the computing device also has access to location-determination information of a third type, wherein the location-determination information of the third type facilitates medium-resolution location determinations in the physical setting, and wherein selecting the location-determination information comprises selecting the location-determination information of the third type.

19. The computing device of claim 17, wherein the operations further comprise:
determining that the particular topography includes a building, wherein the location-determination information of the second type is selected in response to the particular topography including the building.

20. The computing device of claim 17, wherein the operations further comprise:
determining that the particular topography includes a road, wherein the location-determination information of the first type is selected in response to the particular topography including the road.
